(19) United States
(12) Patent Application Publication
(10) Pub. No.: US 2005/0232265 A1
(43) Pub. Date: Oct. 20, 2005

(54) Data transmission method by polling and network device employing the method for data reception

(75) Inventor: Sheng-Yuan Cheng, Chu-Pai City (TW)

Correspondence Address: BRUCE H. TROXELL, 5205 LEESBURG PIKE, SUITE 1404, FALLS CHURCH, VA, 22041, US

(73) Assignee: Infineon-ADMtek Co., Ltd.

(21) Appl. No.: 11/095,587

(22) Filed: Apr. 1, 2005

(30) Foreign Application Priority Data
Apr. 16, 2004 (TW) 93110585

(51) Int. Cl. H04L 12/56

(52) U.S. Cl. 370/389

(57) ABSTRACT

A polling network device, adapted for receiving a frame transmitted from a network, comprising: a first transmission interface, coupled to the network for receiving the frame; a buffer, coupled to the first transmission interface for storing the data in the frame; and a second transmission interface, coupled to the buffer for transmitting the data to a host system, the host system being coupled to the second transmission interface enabling the host system to enquire by polling whether there are data stored in the buffer and enabling the second transmission interface to transmit data to the host system while there are data stored in the buffer. A data transmission method by polling, comprising the steps of: enquiring a network device by a host system by means of polling to check whether there are data stored in a buffer of the network device; and transmitting the data to the host system as there are data stored in the buffer without the requirement of waiting the data to be completely received by the network device.

### FIELD OF THE INVENTION

The present invention relates to a data transmission method by polling and a network device employing the method for data transmission, and more particularly, to a network device with universal serial bus (USB) interfaces capable of transmitting data by polling.

### BACKGROUND OF THE INVENTION

Nowadays, wire network is greatly advanced and widely applied. However, it is not visual acceptable to dispose a lot of wires indoors. Furthermore, it is inconvenient to dispose and will occupy indoor space. To encounter the above problems, wireless network is developed. A conventional wireless local area network (WLAN) adopts IEEE 802.11 wireless communication protocol and transmits data in a manner of frame. When a computer is used for receiving data through radio wave by means of a wireless network card connected therewith, the data are first being transmitted to a buffer of the wireless network card, and then the data is transmitted to the internal memory of the computer through the buffer. However, only after the data are completely transmitted to the buffer, the data can be transmitted to the host system, which adversely affects data transmission throughput of the wireless network.

### SUMMARY OF THE INVENTION

Accordingly, it is the primary object of the present invention to provide a data transmission method by polling and a network device employing the method for data transmission, capable of increasing the network data transmission throughput.

To achieve the above object, the present invention provides a network device adapted for receiving a frame transmitted from a network, comprising: a buffer, capable of storing a data contained in the frame; a first transmission interface, coupled to the network for transmitting the data contained in the frame to the buffer; and a second transmission interface, coupled to the buffer for transmitting the data to a host system, wherein the host system enquires whether the buffer has data stored therein by polling, and the second transmission interface is enabled to transmit data to the host system without wait for the data to be transmitted to the buffer completely.

A data transmission method by polling disclosed in the present invention comprises steps of:
(a) enquiring a network device by a host system by means of polling to check whether there are data stored in a buffer of the network device, and determine whether the data quantity of the buffer reaches a threshold;
(b)transmitting the data to the host system as there are data stored in the buffer without the requirement of waiting the data to be completely received and stored in the buffer of the network device.

Other objects, advantages and novel features of the present invention will be drawn from the following detailed embodiment of the present invention with attached drawings, in which:

### BRIEF DESCRIPTION OF THE DRAWINGS

FIG. 1 is a block diagram of a network device according to a preferred embodiment of the present invention; and

FIG. 2 is a flow chart of a data transmission method by polling according to the present invention.

### DESCRIPTION OF THE PREFERRED EMBODIMENT

A data transmission method by polling and a network device employing the method for data transmission of the present invention are characterized by that a host system enquires by polling whether the network device has data. When the network device has data, it does not need to wait to completely transmit the data to the network device, and the network device immediately transmits the data to the host system.

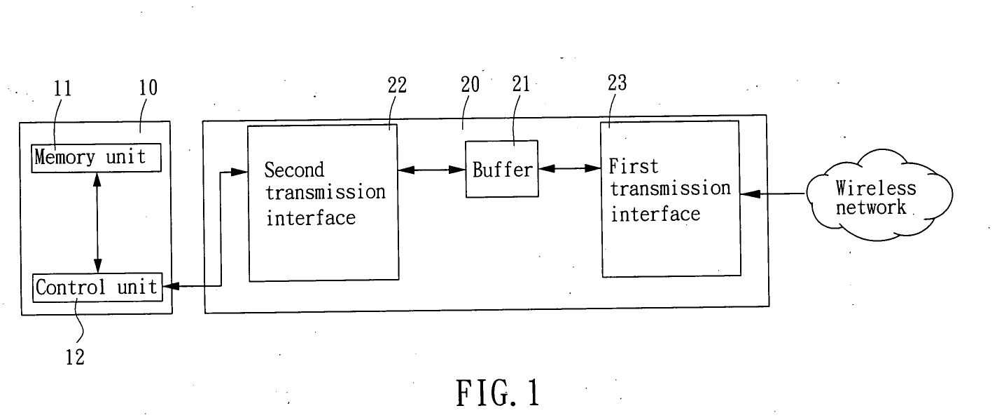

Referring to FIG. 1, a block diagram of a network device in accordance with a preferred embodiment of the present invention is shown. The network device can transmit data of a network to a host system.

The network device is a wireless communication device, and in accordance with wireless communication protocol, the network device receives data in a manner of frame. The frame has a preamble, a header and a frame body. The preamble is employed as a synchronous signal. The header is for indicating data transmission speed and length. The frame body is the data to be received. The network device 20 is a wireless network card and has a first transmission interface 23, a buffer 21 and a second transmission interface 22. The network device 20 receives the frame transmitted from the network through the first transmission interface 23, captures the data in the frame and stores the data in the buffer 21. The second transmission interface 22 connects a host system 10 for data transmission. In the preferred embodiment, the second transmission interface 22 is a USB interface.

The host system 10 is a computer or a PDA and has a memory unit 11 and a control unit 12. The control unit 12 untimely and automatically enquires whether the network device 20 has data to be transmitted. The second transmission interface 22 automatically checks whether the data quantity in the buffer 21 reaches a predetermined threshold (the predetermined threshold is configured in accordance with the readable data quantity of the second transmission interface 22, for example, when the second transmission interface is a USB1.1 interface, the predetermined threshold is configured to be 64 bytes, and when the second transmission interface is a USB2.0 interface, the predetermined threshold is configured to be 512 bytes). When the data quantity of the buffer 21 reaches the predetermined threshold, the second transmission interface 22 starts to read the data of the buffer 21 and transmits the data to the host system 10. The data quantity read by the second transmission interface 22 is the data quantity of the predetermined threshold. In this embodiment, the predetermined threshold is 64 bytes, the data quantity read once by the second transmission interface 22 is 64 bytes. The second transmission interface 22 transmits the data to the memory unit 11 of the host system 10. It does not need to wait to completely transmit the data to the buffer 21. The host system 10 can read the data and transmit the data to the host system 10 through the second transmission interface 22. In addition, when the frame is completely transmitted to the buffer 21 but the data quantity of the buffer 21 does not reach the predetermined threshold, the second transmission interface 22 still transmits the data to the memory unit 11 of the host system 10.

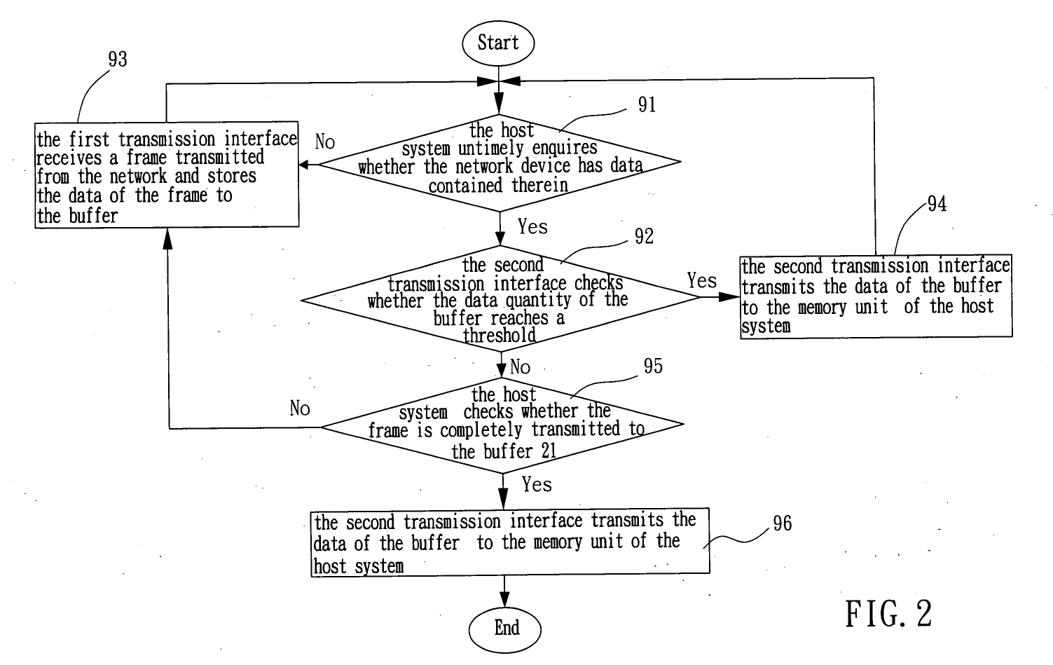

Referring to FIG. 2, a flow chart of a data transmission method by polling according to the present invention is shown. The method may be applied to the above network device for receiving data transmitted from the network, comprising the steps of:
Step 91: the host system 10 enquires by polling whether the network device 10 has data. If so, the flow proceeds to step 92, otherwise, the flow proceeds to step 93.
Step 92: the second transmission interface 22 checks whether the data quantity of the buffer 21 reaches the predetermined threshold. If so, the flow proceeds to step 92, otherwise, the flow proceeds to step 95.
Step 93: the first transmission interface 23 receives a frame transmitted from the network and stores the data in the frame to the buffer 21.
Step 94: the second transmission interface 22 transmits the data of the buffer 21 to the memory unit 11 of the host system 10. The second transmission interface does not need to wait to completely transmit the data to the buffer. The second transmission interface can immediately transmit the data to the memory unit and the data quantity transmitted by the second transmission interface is the same as that of the predetermined threshold.
Step 95: the host system 10 checks whether the frame is completely transmitted to the buffer 21. If so, the flow proceeds to step 96, otherwise, the flow proceeds to step 93.
Step 96: the second transmission interface 22 transmits the data of the buffer 21 to the memory unit 11 of the host system 10.

Through the above described network device and method, the efficiency of receiving data of the network device is increased.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A polling network device, adapted for receiving a frame transmitted from a network, comprising:
a first transmission interface, coupled to the network for receiving the frame;
a buffer, coupled to the first transmission interface for storing data containing in the frame; and
a second transmission interface, coupled to the buffer for transmitting the data to a host system, the host system being coupled to the second transmission interface enabling the host system to enquire by polling whether there are data stored in the buffer and enabling the second transmission interface to transmit data to the host system while there are data stored in the buffer;
wherein, the host system is capable of accessing the data without the requirement of waiting the data to be transmitted to the buffer completely.

2. The network device as claimed in claim 1, wherein the second transmission interface checks whether the data quantity of the buffer reaches a threshold while enquiring by polling is performed by the host system, and then the second transmission interface starts to access the data as the data quantity of the buffer reaches the threshold.

3. The network device as claimed in claim 2, wherein the data quantity accessed by the second transmission interface is the same as that of the threshold.

4. The network device as claimed in claim 2, wherein the second transmission interface checks whether the data are completely transmitted to the buffer, and starts accessing the data and transmitting the same to the host system as the data of the frame are completely transmitted to the buffer but the data quantity does not reach the threshold.

5. The network device as claimed in claim 2, wherein the second transmission interface is an USB interface.

6. The network device as claimed in claim 1, wherein the host system has a memory unit for storing the data.

7. A data transmission method by polling, comprising the steps of:
enquiring a network device by a host system by means of polling to check whether there are data stored in a buffer of the network device; and
transmitting the data to the host system as there are data stored in the buffer without the requirement of waiting the data to be completely received by the network device.

8. The method as claimed in claim 7, further comprising a step of: using a network for transmitting a frame so as to enable the data to be received by the network device.

9. The method as claimed in claim 8, further comprising steps of: performing an evaluation by the network device to determine whether the data quantity of the network device reaches a threshold, and enabling the network device to transmit the data to the host system as the data quantity reaches the threshold.

10. The method as claimed in claim 9, further comprising steps of: performing an evaluation by the network device to determine whether the data of the frame are completely received by the same, and enabling the network device to transmit the data to the host system as the data of the frame is completely received but does not reach the threshold.

11. The method as claimed in claim 7, wherein the network device comprises a buffer for storing the data.

12. The method as claimed in claim 7, wherein the host system has a memory device for storing the data.
